(19) United States
(12) Patent Application Publication
(10) Pub. No.: US 2026/0157574 A1
(43) Pub. Date: Jun. 11, 2026

(54) ROBOTIC KITCHEN APPLIANCE FOR PREPARING FOOD

(71) Applicant: Vamsi K. Kurkal, Ithaca, NY (US)

(72) Inventor: Vamsi K. Kurkal, Ithaca, NY (US)

(21) Appl. No.: 18/975,048

(22) Filed: Dec. 10, 2024

(51) Int. Cl. A47J 44/00; A47J 17/10

(52) U.S. Cl. CPC A47J 44/00; A47J 17/10

(57) ABSTRACT

A robotic appliance includes a body defining a working space. The robotic appliance includes a door movably coupled to the body to allow access to the working space. The robotic appliance includes a first robotic arm coupled to an interior surface of the body and a second robotic arm coupled to the interior surface of the body. The robotic appliance includes one or more cameras coupled to the interior surface of the body. The robotic appliance also includes a computing device electrically coupled to the first robotic arm, the second robotic arm, and the one or more cameras and storing instruction to perform a method of performing an action on a food item.

### FIELD

The present disclosure relates to kitchen appliances and, more particularly, to robotic kitchen appliances.

### BACKGROUND

Currently, many kitchen tasks require a person to perform various manual tasks that can require physical effort or dexterity. For example, chopping vegetables requires the person to hold the vegetable in one hand and operate a knife with the other hand. The process may be difficult for some people if the person lack the physical dexterity or skill to perform the task, e.g., a young person, an elderly person, a disabled person, etc.

As can be seen, there is a need for systems and method that addresses the above drawbacks.

### SUMMARY

In one aspect of the present disclosure, a robotic appliance includes a body defining a working space. The robotic appliance includes a door movably coupled to the body to allow access to the working space. The robotic appliance includes a first robotic arm coupled to an interior surface of the body and a second robotic arm coupled to the interior surface of the body. The robotic appliance includes one or more cameras coupled to the interior surface of the body. The robotic appliance also includes a computing device electrically coupled to the first robotic arm, the second robotic arm, and the one or more cameras and storing instruction to perform a method. The method includes receiving input from a user to perform an action on a food item. The method includes receiving, from the one or more cameras, image data of the working space. The method includes applying the image data to one or more machine learning models that are trained to output instruction for performing potential actions on types of food items. The method includes transmitting, to the first robotic arm and the second robotic arm, one or more control signals to perform the action based on output from the one or more machine leaning models.

### BRIEF DESCRIPTION OF THE DRAWINGS

FIG. 1 is a top-front perspective view of a robotic appliance, according to aspects of the present disclosure;

FIG. 2 is a bottom-front perspective view of the robotic appliance of FIG. 1, according to aspects of the present disclosure;

FIG. 3 is another top-front perspective view of the robotic appliance of FIG. 1, according to aspects of the present disclosure;

FIG. 4 is a top-side perspective view of the robotic appliance of FIG. 1, according to aspects of the present disclosure;

FIG. 5 is another top-side perspective view of components of the robotic appliance of FIG. 1, according to aspects of the present disclosure;

FIG. 6 is another top-front perspective view of the robotic appliance of FIG. 1, according to aspects of the present disclosure; and

FIG. 7-14 are various views of a process of using the robotic appliance of FIG. 1, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, systems and devices are needed that can assist in kitchen tasks. Most robotic systems are expansive systems that either consist of a full human robotic system or involve massive infrastructure built into a structure housing the robotic system. Full human-robotic systems are generic and take significant effort and time to train and develop to be useful. Robotic systems that require custom installation and full built-in infrastructure are too expensive and disruptive to implement for the average household. Moreover, current solutions to assist in ingredient preparation consist of specialized machined parts which need to be swapped out for different ingredients or actions. The parts may or may not still require manual operation and the parts may also require extensive cleaning after operation.

Broadly, an embodiment of the present disclosure provides a robotic appliance that allows for robotic preparation of cooking ingredients without human hands involved. The robotic appliance utilizing two robotic arms with at least 3 degrees of freedom, several onboard cameras and an on-board computer. The robotic appliance utilizes cameras to provide telemetry to an artificial intelligence (AI) driven software control deployed on the computer to manipulate cooking ingredients and available tools to prepare an ingredient via cutting, peeling, dicing, and more. The arms and tools and working area are contained in a cubic frame enclosed by a front-loading door to ensure safety of the user during robotic operation.

The robotic appliance enables disabled and/or elderly persons and those without ample time leverage the robotic appliance to assist in cooking ingredient preparation. Moreover, the robotic appliance can be moved around and plugged into an electrical outlet and as such does not need expansive installation. Additionally, does not require any other infrastructure other than an electrical outlet and kitchen counter space. It will aid in cooking ingredient preparation with limited human manual operation and as such will improve independence of elderly and disabled peoples as well as enhance the lives of those who wish to use the apparatus to save them time.

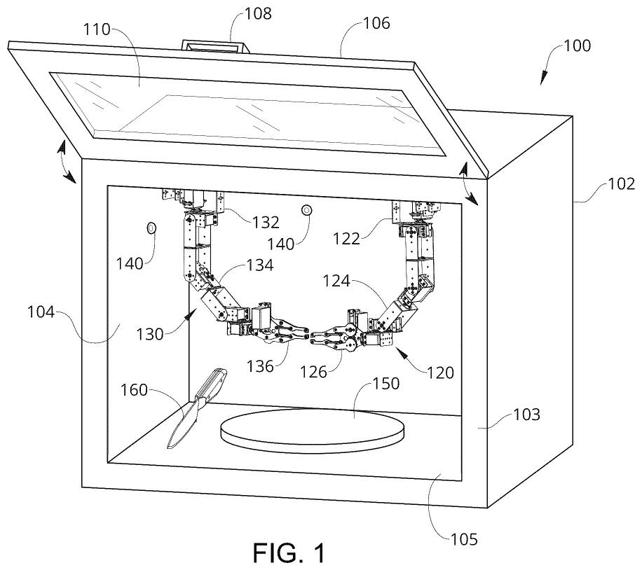

Referring now to FIG. 1-14, FIG. 1-5 illustrates various views of a robotic appliance 100, according to aspects of the present disclosure. While FIGS. 1-5 illustrate examples of components of the robotic appliance 100, additional components can be added and existing components can be removed and/or modified.

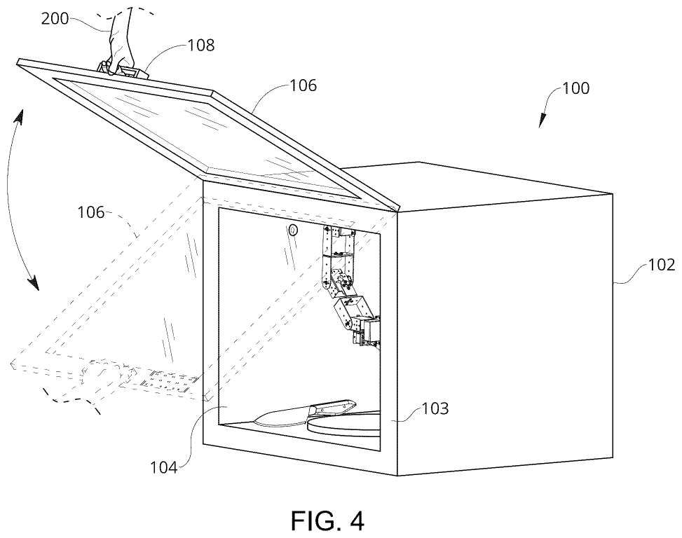

As illustrated in FIGS. 1-5, the robotic appliance 100 includes a body 102 that is formed having a cubic shape. The body 102 defines a working space 104 within the body 102. The robotic appliance 100 includes a door 106 coupled to a front surface 103 of the body 102. The door 106 can be opened and closed using a handle 108 coupled to the door 106, for example, by a user 200 as illustrated in FIG. 4. The door 106 can also include a window 110 constructed of a transparent or semi-transparent material. When the door 106 is closed, the window 110 allow a user to view content within the working space 104.

The robotic appliance 100 can include a plate 150 positioned on a bottom surface 105 within the working space 104. As illustrated in FIG. 4, the plate 150 can be removed from the body 102 of the robotic appliance 100. In one example, the plate 150 can be circular in shape. The plate 150 can be used as platform for food items that can be processed within the working space by the robotic appliance 100.

The robotic appliance 100 can include two robotic arms, a robotic arm 120 and a robotic arm 130. The robotic arm 120 is coupled to an interior top surface of the body 102 by a mounting backet 122. The robotic arm 130 is coupled to the interior top surface of the body 102 by a mounting bracket 132. The robotic arm 120 includes a number of segments 124 and an end effector 126. The robotic arm 120 is configured to move in at least 3 degrees of freedom, via the segments 124 and the connection with the mounting bracket 122. The end effector 126 can include a grasping mechanism, e.g., pincers, that operator to grab, hold, and manipulate a tool 160 and/or a food item placed on the plate 150. The robotic arm 130 include a number of segment 134 and an end effector 136. The robotic arm 130 is configured to move in at least 3 degrees of freedom, via the segments 134 and the connection with the mounting bracket 132. The end effector 136 can include a grasping mechanism, e.g., pincers, that operator to grab, hold, and manipulate the tool 160 and/or a food item placed on the plate 150. The tool 160 can be any type of tool used in food preparation such as a knife, scissors, fork spoon, grater, a peeler, a masher, etc.

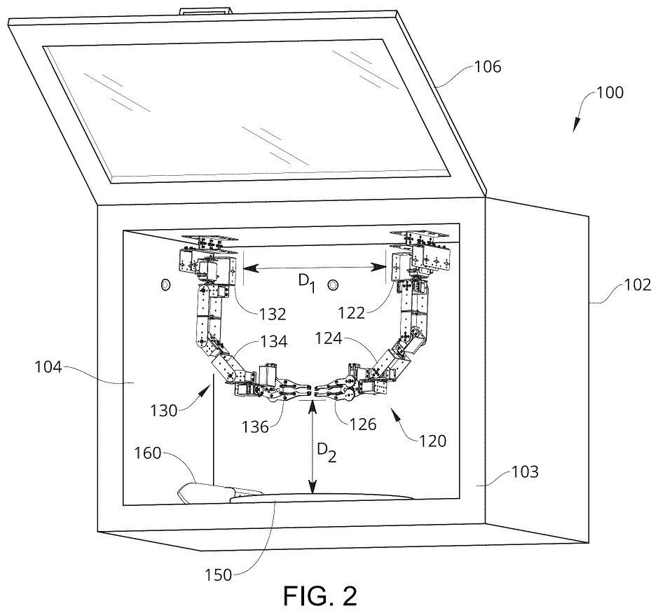

The robotic arm 120 and the robotic arm 130 can include a drive mechanism (e.g., pneumatic drive, cable drive, chain drive, etc.) that causes the movement of the robotic arm 120 and the robotic arm 130. As illustrated in FIG. 2, the mounting bracket 122 and the mounting bracket 132 can be spaced apart a distance D1 such that the robotic arm 120 and the robotic arm 130 can reach the areas with the working space 104 without interfering. At resting positions, the robotic arm 120 and the robotic arm 130 can be positioned a distance D2 above the plate 150, allowing food items to be placed on the plate 150.

While FIGS. 1-5 illustrate 2 robotic arms, in some embodiment, the robotic appliance 100 can include additional robotic arms. While FIGS. 1-5 illustrate a single tool 160, the robotic appliance 100 can include additional tools, whether the same or different types. Additionally, the robotic appliance 100 can include an organizer to hold the tools 160. While FIG. 1-5 illustrate the end effectors as including pincers, the end effectors can include other devices for holding the tool 160 and/or the food times, e.g., bolting mechanism, magnetic mechanism, a spike, a robotic hand, etc.

The robotic appliance 100 also includes one or more camera 140. Fore example, the robotic appliance 100 can include 3 cameras 140 positioned on the interior surfaces of the body 102. The cameras 140 are positioned to provide imaging on the working space 104. For example, the cameras 140 are on the three internal sides of the body 102 with viewpoints that encompass the robotic arms 120 and 130, the tool 160, and the plate 150.

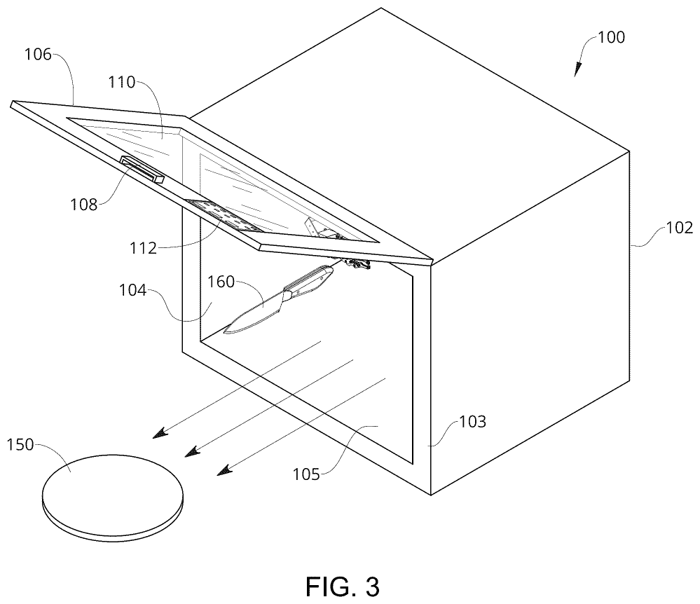

As illustrated in FIG. 3, the door 106 can include a control interface 112. The control interface allows a user to input a desired action to be take by the robotic appliance 100 and indicate a progress of the desired action. The control interface 112 can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The control interface 112 can include an acoustic element such as a speaker, a microphone, and so forth. The control interface 112 can include a button, a switch, a keyboard, a touch-sensitive surface, a touchscreen, a camera, a fingerprint scanner, and so forth. The touchscreen can include a resistive touchscreen, a capacitive touchscreen, and so forth.

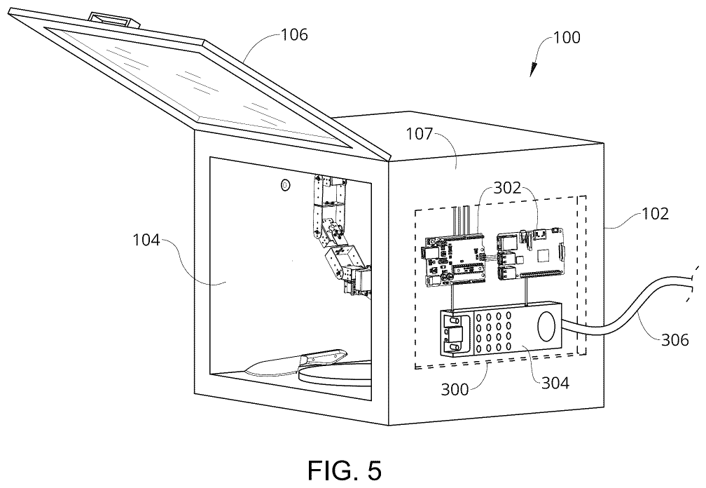

As illustrated in FIG. 5, the robotic appliance 100 an onboard computer 300 that includes microcontroller(s) 302, a power supply 304, and power cord 306. The onboard computer is electrically coupled to the robotic arm 120, the robotic arm 130, the cameras 140, and the control interface 112. The onboard computer 300 stores hardware and software that supports an ai driven image to control signal software pipeline connected to the microcontroller 302. The microcontroller 302 can control the robotic arm 120 and the robotic arm 130 to complete tasks. For example, the onboard computer 300 can be is housed within the body 102. The power supply 304 supplies power to the robotic appliance 100.

The robotic appliance 100 leverages the microcontroller 302 that is fed signals from the onboard computer 300 that stores AI models that are fed telemetry from cameras 140 to operate the robotic arm 120 and the robotic arm 130 equipped with the tool 106 and to prepare a food item in the manner selected from the control interface 112.

The onboard computer 300 an onboard AI (one or more machine learning modules) that has been trained to process camera 140 input and generate control signals that can be leveraged by the microcontroller 302 to move the the robotic arm 120 and the robotic arm 130. Training data includes having the AI solve object grasping problems on the selected ingredient, as well as soft-body manipulation and tool wielding.

The AI is trained using an interaction-based approach to learn semantically rich representations for the task of slicing vegetables. The training methodology is specialized onto a limited set of ingredients and food items and limited scope of actions, but as ingredient support and action support is trained, the updated models and processes can be sent to the end users via an OTA updated. The onboard computer 300 can include communication devices, as described below, to receive updates and communication with one or more user devices, which can control the robotic appliance 100.

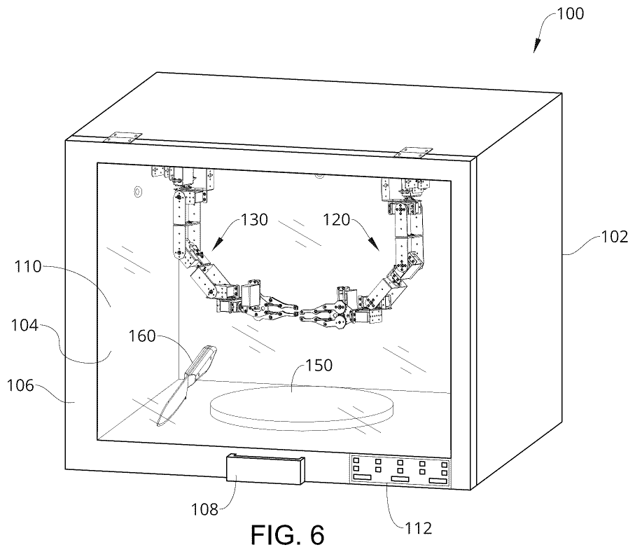

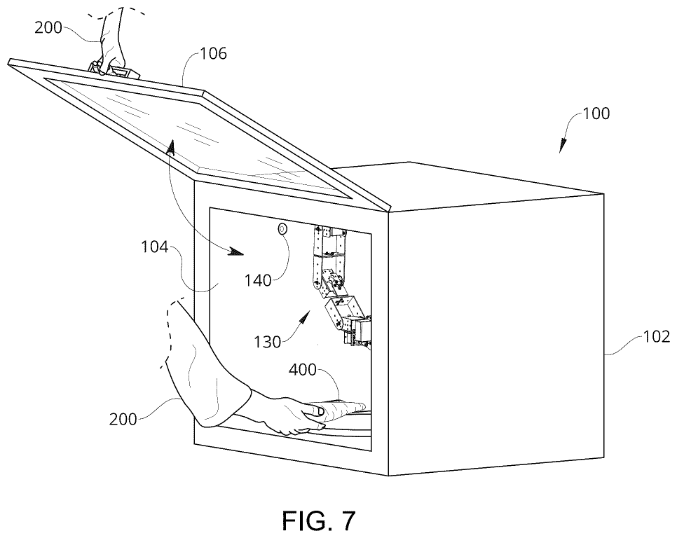

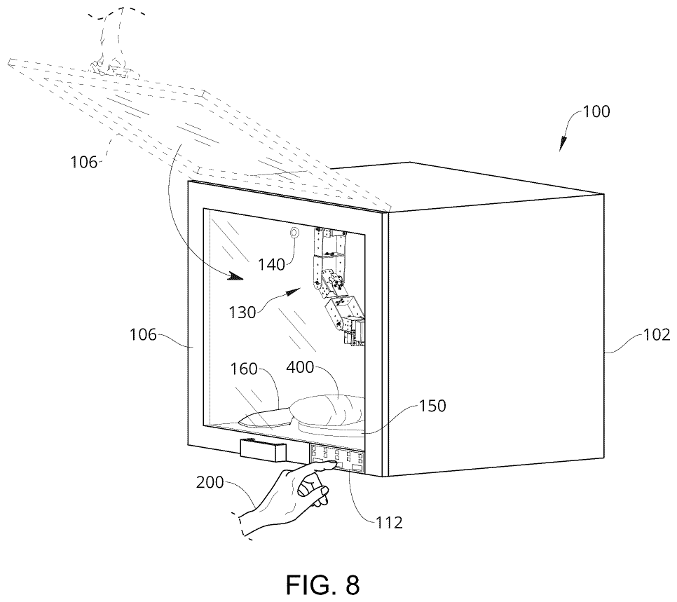

FIG. 6-14 illustrate the operation of the robotic appliance 100. As illustrated in FIGS. 6 and 7, the user 200 can open the door 106, and place the food item 400, e.g., carrot, onto the plate 150 and place the plate in the working area 104. As illustrated in FIG. 8, the user 200 then closes the door 106 and input a desired action into the control interface 112.

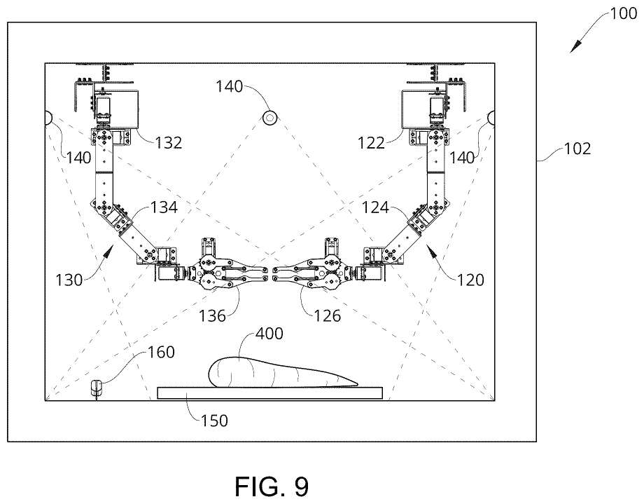

As illustrated in FIG. 9, after input selection, the cameras 140 activate and begin sending telemetry to the onboard computer 300, while the onboard computer 300 connects to the robotic arms, the robotic arm 120 and the robotic arm 130 via the microcontroller 302 and sends commands to it generated by the onboard AI.

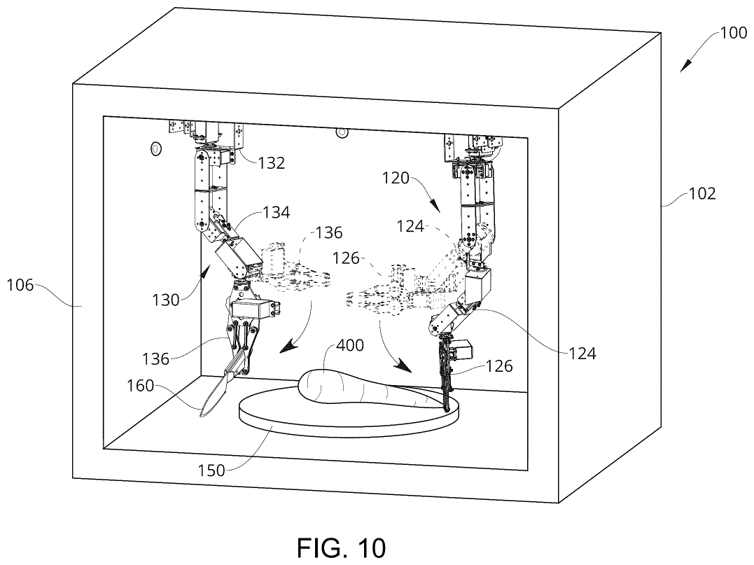

As illustrated in FIG. 10, one of the robotic arms, e.g., the robotic arm 130, accesses the relevant tool 160, e.g., knife, while the other robotic arm, e.g., the robotic arm 120, grabs and positions the food item 400 that is placed on the plate 150.

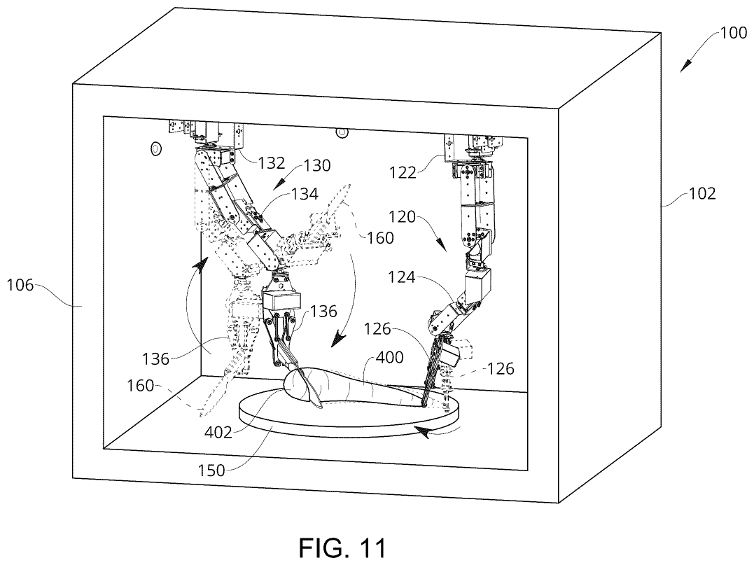

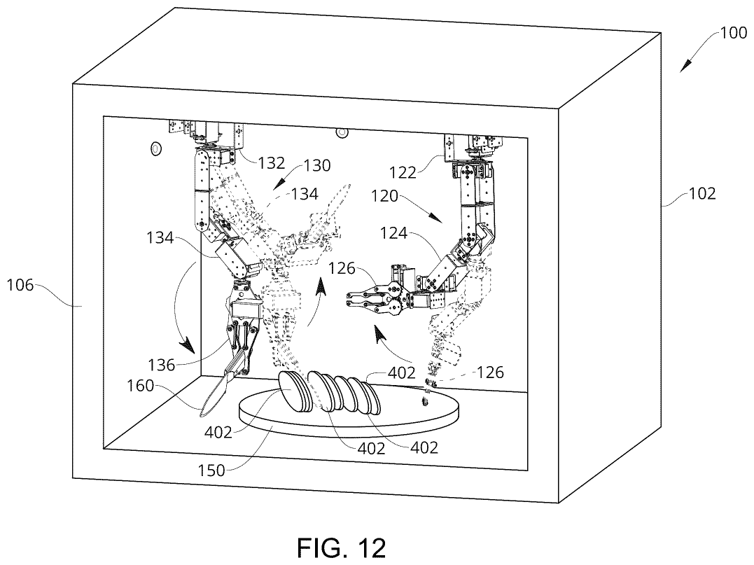

As illustrated in FIGS. 11 and 12, the robotic arm 120 and the robotic arm 130 are then driven by the microcontroller 302 which is directed by an onboard computer 300 that is fed telemetry by the cameras 140 and leverages various AI models to generate commands to execute the user selected action upon the food item 400 placed on the plate 150. For example, the user may have selected chopping. In response, the robotic arm 130 uses the tool 160 to cut segments 402 of the food item 400.

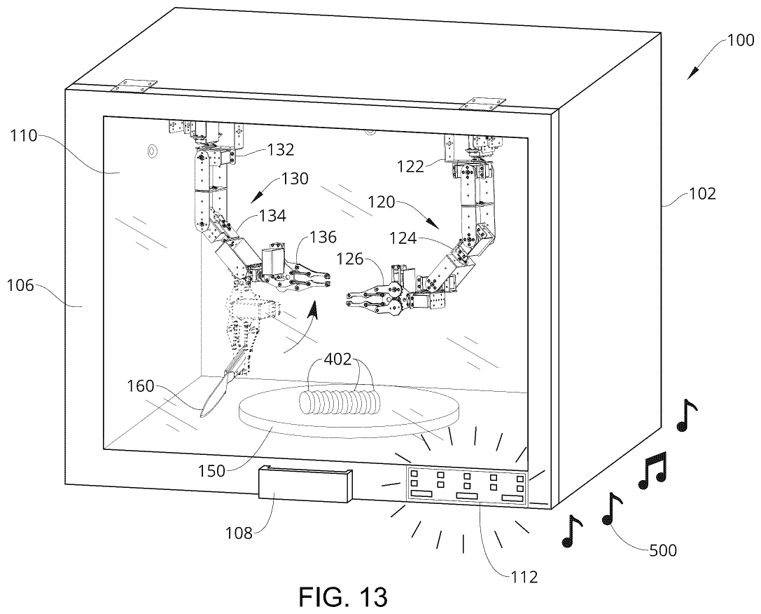

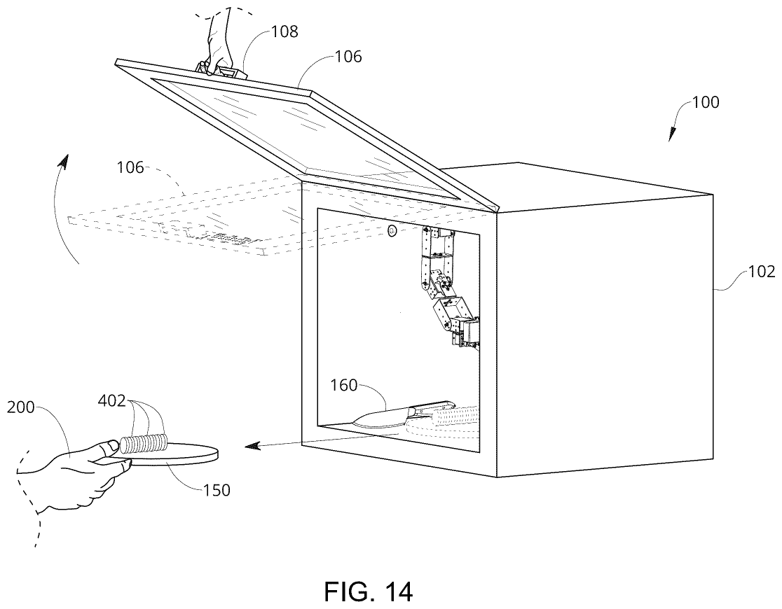

The robotic arm 120 and the robotic arm 130 work in tandem to position the food item 400 and execute the action until the onboard computer 300 indicates completion as it processes the camera 140 data. As illustrated in FIG. 13, the robotic arm 120 then releases the ingredient, and the robotic arm 130 return the tool 140 to its original place. The robotic arm 120 and the robotic arm 130 then move to their standby position, while the control interface 112 displays an audiovisual prompt to indicate action completed. As illustrated in FIG. 14, the user 200 then opens the door 106 and removes the plate 150 with the prepared food item 402.

In embodiments, the on-board computer 300 can includes a processing device coupled to a communication device. The processing device is also coupled to a memory device, and an input/output (“I/O”) interface. The processing device, the communication device, the memory device, and the I/O interface can be interconnected via a system bus. The system bus can be and/or include a control bus, a data bus, an address bus, and the like. The processing device can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device.

The memory device can be and/or include one or more computerized storage media capable of storing electronic data temporarily, semi-permanently, or permanently. The memory device can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device.

The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

While the robotic appliance 100 is illustrated as a table top appliance, such as a microwave. The robotic appliance 100 can be configured into other form factors, such as larger appliances such as ranges and ovens.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A robotic appliance, comprising:
a body defining a working space;
a door movably coupled to the body to allow access to the working space;
a first robotic arm coupled to an interior surface of the body;
a second robotic arm coupled to the interior surface of the body;
one or more cameras coupled to the interior surface of the body; and
a computing device electrically coupled to the first robotic arm, the second robotic arm, and the one or more cameras and storing instruction to perform a method comprising:
receiving input from a user to perform an action on a food item,
receiving, from the one or more cameras, image data of the working space,
applying the image data to one or more machine learning models that are trained to output instruction for performing potential actions on types of food items, and
transmitting, to the first robotic arm and the second robotic arm, one or more control signals to perform the action based on output from the one or more machine leaning models.

2. The robotic appliance of claim 1, further comprising:
a control interface electrically coupled to the computer device and configured to receive the input from a user.

3. The robotic appliance of claim 1, further comprising:
a removable plate configured to be positioned within the working space.

4. The robotic appliance of claim 1, wherein the first robotic arm or the second robotic arm comprises:
an end effector coupled to a distal end of the robotic arm and configured to engage with the food item or a tool to perform the action.

5. The robotic appliance of claim 4, wherein the end effector comprises a pincer.

6. The robotic appliance of claim 1, wherein the first robotic arm or the second robotic arm comprises:
a mounting bracket coupled to the interior surface of the body; and
a plurality of segments, wherein mounting bracket and the plurality of segments allow movement in at least three degrees of freedom.

7. The robotic appliance of claim 1, wherein the computer device further comprises:
a communication device for receiving the input from a user device.
